(19) United States
(12) Patent Application Publication
(10) Pub. No.: US 2017/0288922 A1
(43) Pub. Date: Oct. 5, 2017

(54) FREQUENCY ESTIMATION AND TRACKING IN A RECEIVER

(71) Applicant: QUALCOMM Incorporated, San Diego, CA (US)

(72) Inventors: Koorosh Akhavan, San Diego, CA (US); Eunmo Kang, San Diego, CA (US); Rajapaksa Senaratne, San Diego, CA (US)

(21) Appl. No.: 15/269,852

(22) Filed: Sep. 19, 2016

Related U.S. Application Data
(60) Provisional application No. 62/314,963, filed on Mar. 29, 2016.

(51) Int. Cl. H04L 27/20; H04L 27/34; H04L 27/26

(52) U.S. Cl. CPC H04L 27/2017; H04L 27/2688; H04L 27/34

(57) ABSTRACT

In one aspect, a method for estimating residual carrier frequency offset (CFO) in a phase-modulated wireless signal having pseudo noise (PN) spreading is provided. The method includes receiving, at a digital transceiver, a plurality of PN spread blocks of in-phase and quadrature (I/Q) samples of the phase-modulated wireless signal and performing sample-level de-rotation, symbol-level de-spreading, and sign alignment. The method also includes estimating a phase difference and determining an estimated residual CFO based on the phase difference.

### CROSS-REFERENCE TO RELATED APPLICATION

The present Application for Patent claims the benefit of U.S. Provisional Application No. 62/314,963, entitled “FREQUENCY ESTIMATION AND TRACKING IN A RECEIVER” filed Mar. 29, 2016, assigned to the assignee hereof, and expressly incorporated herein by reference in its entirety.

### FIELD OF DISCLOSURE

Disclosed aspects relate to a receiver of wireless signals. More specifically, exemplary aspects are directed to improvements in carrier frequency offset estimation in the receiver.

### BACKGROUND

Wireless communication systems may include transmitters and receivers (or combinations thereof) of wireless signals. The wireless signals may be received at a carrier frequency controlled by a transmitter-side oscillator (e.g., a crystal oscillator (XO)). Similarly, a receiver-side oscillator may control the frequency at which a receiver operates to receive the wireless signals. Although it is desirable for the transmitter-side oscillator and receiver-side oscillator to be synchronized in frequency, precise synchronization may not be possible due to various operating conditions, manufacturing variations, etc. Accordingly, there may be a mismatch in frequencies, referred to as a carrier frequency offset (CFO) between the transmitter-side and the receiver-side crystal oscillators.

While phase-locked loops (PLLs) may be utilized in coherent receivers to track changes in the CFO, frequency-tracking loops (FTLs) may be uses in non-coherent receivers to track changes in CFO. In operation, upon each FTL update, a new estimate for CFO is converted to phases increments per sample to derotate incoming samples (e.g., I/Q (in-phase and quadrature) samples) before the samples enter the non-coherent demodulator.

There is a recognized need for accurate CFO estimation techniques for improved performance of the receivers.

### SUMMARY

The following presents a simplified summary relating to one or more aspects disclosed herein. Systems and methods are directed to residual carrier frequency offset (CFO) estimation in a receiver.

In one aspect, a method for estimating residual carrier frequency offset (CFO) in a phase-modulated wireless signal having pseudo noise (PN) spreading is provided. The method includes receiving, at a digital transceiver, a plurality of PN spread blocks of in-phase and quadrature (I/Q) samples of the phase-modulated wireless signal and performing sample-level de-rotation, symbol-level de-spreading, and sign alignment. The method also includes estimating a phase difference and determining an estimated residual CFO based on the phase difference.

In another aspect, a wireless device includes a digital transceiver, a memory, and a processor. The processor is coupled to the memory to access and execute instructions included in program code stored in the memory to direct the wireless device to: (i) receive, at the digital transceiver, a plurality of pseudo noise (PN) spread blocks of in-phase and quadrature (I/Q) samples of the phase-modulated wireless signal; (ii) perform sample-level de-rotation; (iii) perform symbol-level de-spreading; (iv) estimate a phase difference; and (vi) determine an estimated residual CFO based on the phase difference.

According to yet another aspect, a non-transitory computer-readable medium including program code stored thereon for performing wireless communications by a wireless device. The program code includes instructions to: (i) receive, at a digital transceiver of the wireless device, a plurality of pseudo noise (PN) spread blocks of in-phase and quadrature (I/Q) samples of the phase-modulated wireless signal; (ii) perform sample-level de-rotation and accumulation of the I/Q samples during a respective modulated symbol period of the I/Q samples; (iii) perform symbol-level de-spreading within each of the plurality of PN spread blocks to generate a plurality of de-spread blocks; (iv) perform sign alignment on the de-spread blocks to generate sign-aligned blocks; (v) estimate a phase difference between two or more adjacent sign-aligned blocks; and (vi) determine an estimated residual CFO based on the phase difference.

### BRIEF DESCRIPTION OF THE DRAWINGS

The accompanying drawings are presented to aid in the description of aspects of the invention and are provided solely for illustration of the aspects and not limitation thereof

FIG. 1 illustrates the phase at different stages of demodulation.

FIG. 2A illustrates both a zero frequency error and a non-zero frequency error.

FIG. 2B illustrates an example estimation of frequency error using coded blocks, according to aspects of the disclosure.

FIG. 3 is an example block diagram of a frequency estimation block, according to aspects of the disclosure.

FIG. 4 is an example block diagram of a rotator, according to aspects of the disclosure.

FIG. 5 illustrates a geometrical representation of frequency estimation and tracking, according to aspects of the disclosure.

FIG. 6 illustrates an example wireless transceiver with receiver-side processing, according to aspects of the disclosure.

FIG. 7 illustrates example wireless devices, according to aspects of the disclosure.

FIG. 8 illustrates an example process for residual carrier frequency offset estimation, according to aspects of the disclosure.

### DETAILED DESCRIPTION

Various aspects are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an”, and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof

Further, many aspects are described in terms of sequences of actions to be performed by, for example, elements of a computing device. It will be recognized that various actions described herein can be performed by specific circuits (e.g., application specific integrated circuits (ASICs)), by program code being executed by one or more processors, or by a combination of both. Additionally, these sequence of actions described herein can be considered to be embodied entirely within any form of non-transitory computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter.

Exemplary aspects of this disclosure are directed to frequency estimation and tracking (e.g., residual carrier frequency offset (CFO) estimation) in a digital transceiver of wireless signals. Although an initial CFO estimation may be performed during packet acquisition, the initial CFO estimate sometimes lacks the accuracy needed for the demodulator to operate at sensitivity. Hence, a frequency tracking loop (FTL) may be used to help improve the initial estimate. In addition, CFO is not always constant and may vary with time and within the packet. The FTL also helps with tracking the time varying CFO. Accordingly, aspects of the present disclosure may include determining an initial CFO of a phase-modulated wireless signal and then subsequently tracking changes in the initial CFO. The subsequent changes from the initial CFO may be referred to herein as a residual CFO estimate.

In one aspect, frequency estimation and tracking can be utilized with non-coherent detection of offset-quadrature phase shift key (O-QPSK), minimum shift key (MSK) and Gaussian minimum shift key (GMSK) signaling scheme such as the ones defined under IEEE-802.15.4 PHY and IEEE-802.15.1 PHY.

Further aspects of the present disclosure may be configured to not compromise the receiver performance even when the transceiver is designed to have high sensitivity by utilizing the processing gain and/or coding gain (introduced at the transmitter via spreading and/or block coding, respectively). Other aspects may directly exploit the internal design of a non-coherent maximum-likelihood demodulator by recognizing the fact that any phase change in the demodulator correlator output, derived from applying ML criterion, is directly proportional to frequency error. As a result, if such demodulation scheme is used, the residual CFO estimation comes for free, i.e., no additional hardware is required. However, the residual CFO estimation can be also separately implemented in hardware and used with other non-coherent demodulator architectures.

The processes discussed herein can be equally applied to any combination of direct-sequence spread spectrum modulation, block-coded modulation or uncoded modulation for O-QPSK, MSK, GMSK or any similar modulation in the continuous-phase modulation (CPM) family. However, for ease of explanation, the following detailed description provides examples of a block-coded O-QPSK signaling such as one defined in IEEE-802.15.4 to describe the process.

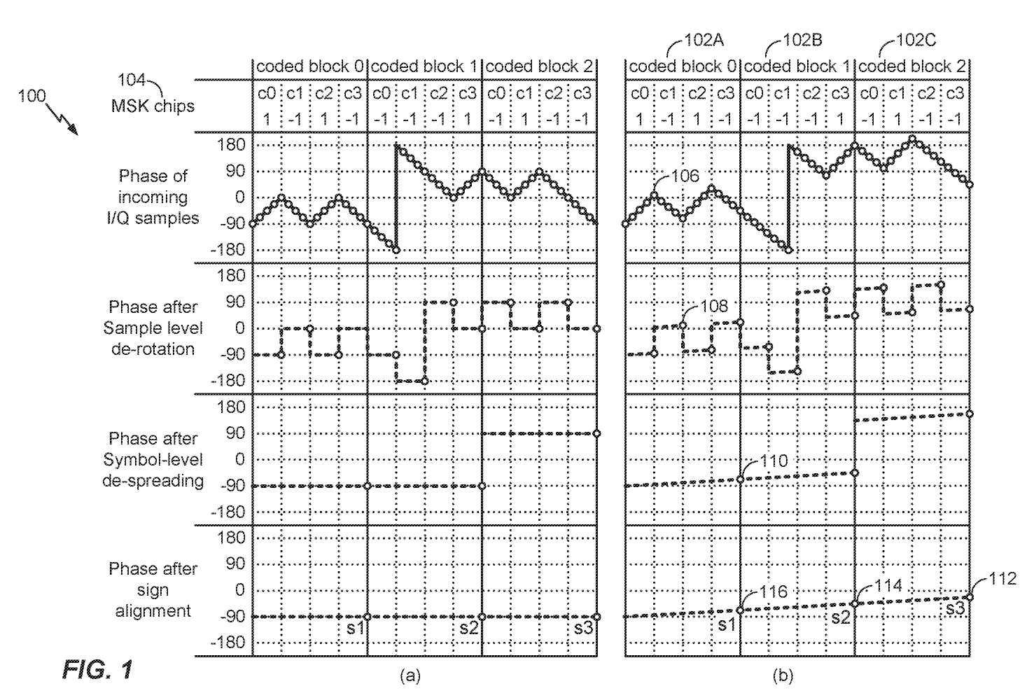

As discussed above, CFO is the result of mismatch between the frequency of the incoming modulated carrier and the frequency of receiver mixer LO. The receiver analog mixer is designed to convert the incoming modulated carrier down to zero frequency, but the mismatch usually leads to a non-zero frequency offset. This offset manifests as phase drift across received samples. In the case of minimum-shift keying (MSK) signaling (which is very similar to O-QPSK signaling), the phase drift causes the phase trellis to diverge from its original path. This fact is shown in FIG. 1.

The phase trellis can be used inside the non-coherent block demodulator to detect individual received blocks of samples by means of sample-level de-rotation and accumulation within each modulation symbol followed by symbol-level de-spreading within each block. For example in IEEE 802.15.4 O-QPSK PHY, each coded block is made up of N=32 chips (N=4 in the figure to make it easy to illustrate) and within every chip there are M ADC samples (M=4 in the figure). The demodulator first carries out sample-level de-rotation to align the M samples of every chip and sums them up. The N chips formed this way are ±90 degrees apart from their neighboring chips. The symbol-level de-spreader removes this phase difference so that all 32 chips have the same phase φ₀, the phase of the first sample in the coded block, and then adds them all up. Thus, the symbol-level de-spreader output for each coded block will have the phase of the first sample in that coded block.

The symbol-level de-spreader output of each coded block is either in phase or 180 degrees out of phase with the de-spreader output of the previous coded block depending on whether the last chip of the previous coded block is −1 or 1, respectively. The sign of the last chip can therefore be used to align all the de-spreader outputs.

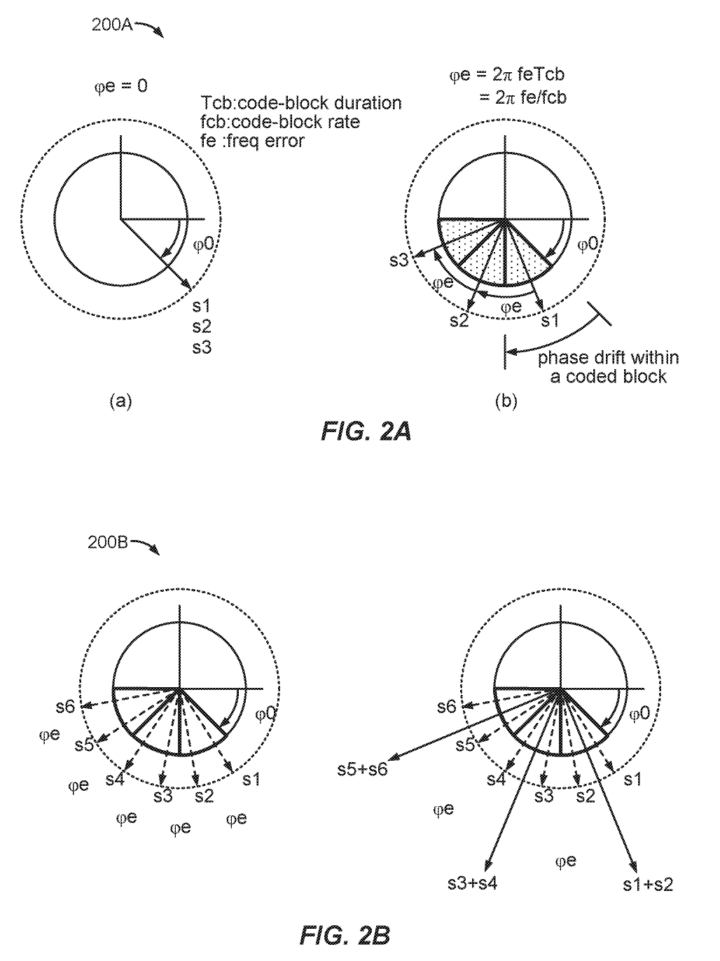

As shown in FIGS. 1 and 2A-2B, the symbol-level de-spreader output (after sign alignment) of the n-th coded block is denoted by sₙ. When there is zero frequency error, all de-spreader outputs sₙ fall on top of each other as shown in left-side (a) of FIG. 2A. When there is non-zero frequency error, the de-spreader output for each coded block rotates by an angle φₑ =2πfₑ/f_{cb} with respect to the previous coded block (see, right-side (b) FIG. 2A). Here fₑ is the frequency error and f_{cb} is the coded-block rate. Therefore, aspects of the present disclosure include may include estimating the residual CFO by computing the angle between the de-spreader outputs of two adjacent coded blocks.

In one aspect, the method described above can be further extended to use more than just two adjacent coded blocks. For example in FIG. 2B phase difference between s₀=s₁ and s₂=s₃ (which is 4πfₑ/f_{cb}) can be used to estimate the frequency error.

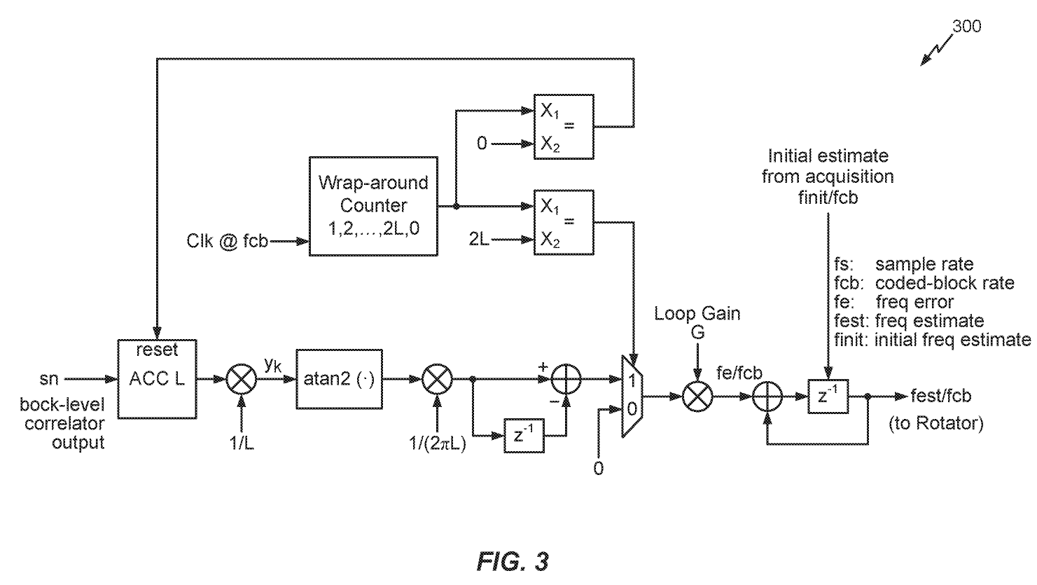

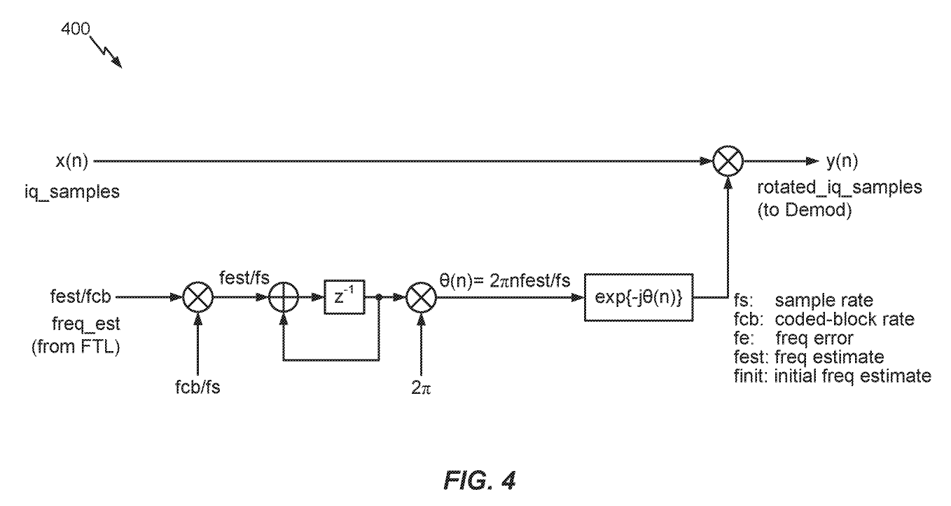

The high-level block diagram of a frequency estimation block 300 is shown in FIG. 3. Frequency estimation block 300 receives the initial CFO estimate from the acquisition block and uses its own frequency error estimates to periodically update the CFO. The CFO updates (normalized to coded-block rate) from the estimation block are then used to calculate the proper phase to rotate the IQ samples inside the rotator (see rotator 400 of FIG. 4).

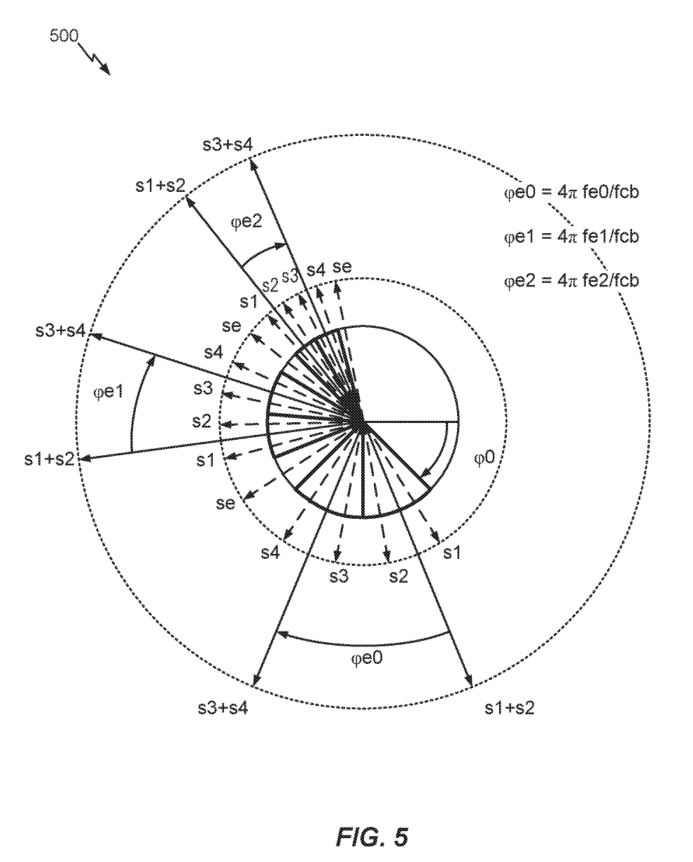

A geometrical representation 500 of the estimation operation using L=2 is shown in FIG. 5. Time progression is clock-wise from S1. The calculated frequency error is used to improve CFO estimate, therefore error gets smaller each time. The sₑ represents an extra coded block that is not used for estimation but rather used for updating the CFO.

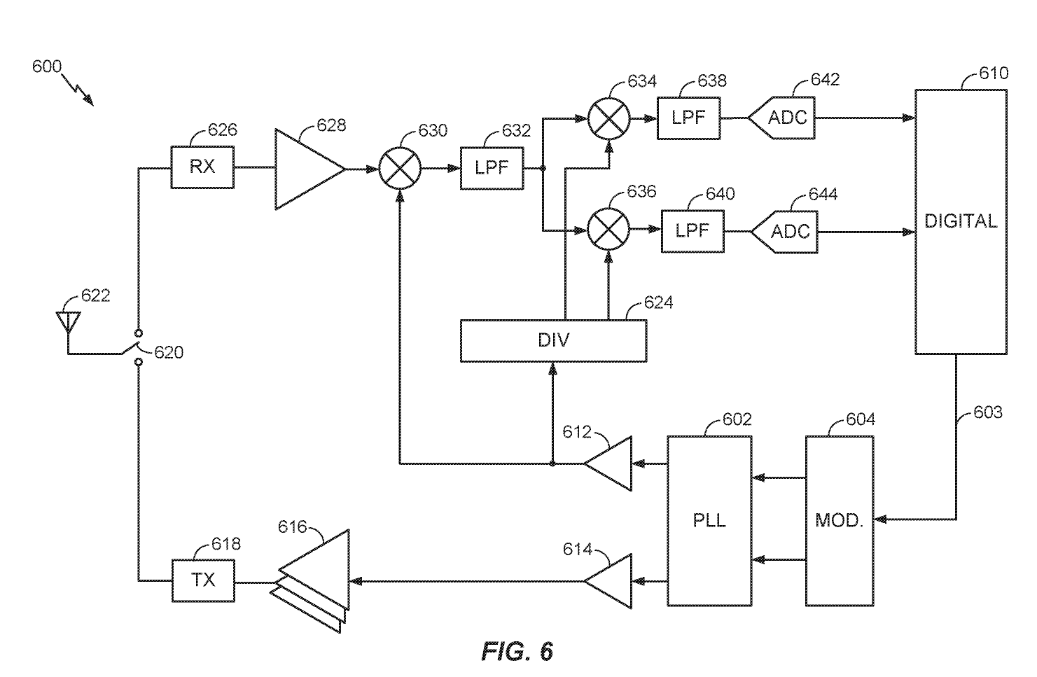

FIG. 6 illustrates an example wireless digital transceiver 600 according to aspects of the disclosure. The illustrated example of wireless digital transceiver 600 includes PLL 602, modulator 604, digital controller 610, buffers 612 and 614, transmit amplifiers 616, transmit matching network 618, transmit/receive switch 620, antenna 622, divider 624, receive matching network 626, front end amplifier 628, mixer 630, low pass filter 632, mixers 634 and 636, low pass filters 638 and 640, and analog-to-digital converters (ADCs) 642 and 644. Wireless digital transceiver 600 is illustrated as having distinct transmit and receive processing paths. Exemplary aspects of this disclosure may be applicable to the receive processing path, as discussed in the above sections. For example, in one possible implementation, frequency estimation block 300 and or rotator 400 may be implemented by digital controller 610, which in one example may be a digital baseband processor.

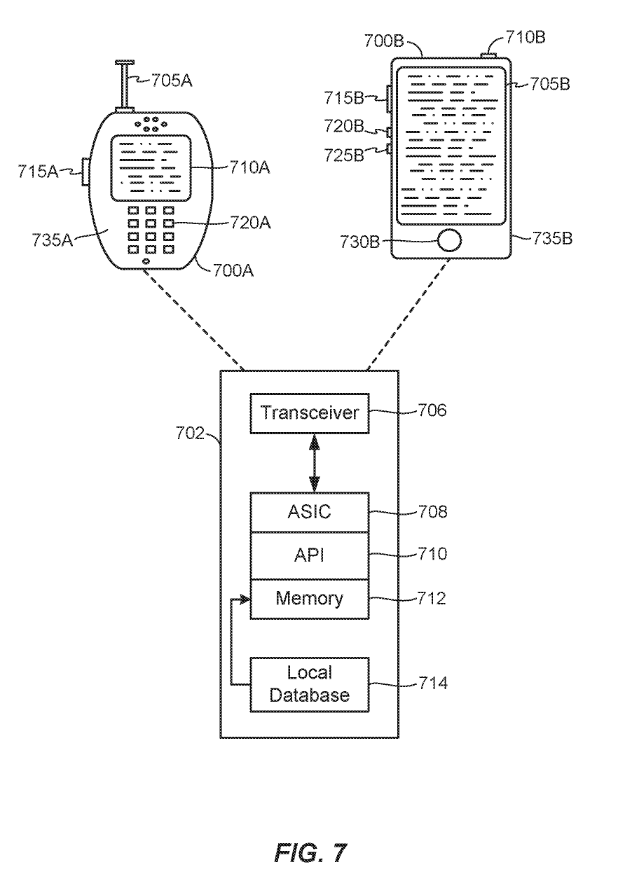

With reference now to FIG. 7, example wireless devices 700A and 700B, according to aspects of the disclosure are illustrated. In some examples, wireless devices 700A and 700B may herein be referred to as wireless mobile stations. The example wireless device 700A is illustrated in FIG. 7 as a calling telephone and wireless device 700B is illustrated as a touchscreen device (e.g., a smart phone, a tablet computer, etc.). As shown in FIG. 7, an exterior housing 735A of wireless device 700A is configured with antenna 705A, display 710A, at least one button 715A (e.g., a PTT button, a power button, a volume control button, etc.) and keypad 720A among other components, not shown in FIG. 7 for clarity. An exterior housing 735B of wireless device 700B is configured with touchscreen display 705B, peripheral buttons 710B, 715B, 720B and 725B (e.g., a power control button, a volume or vibrate control button, an airplane mode toggle button, etc.), at least one front-panel button 730B (e.g., a Home button, etc.), among other components, not shown in FIG. 7 for clarity. For example, while not shown explicitly as part of wireless device 700B, wireless device 700B may include one or more external antennas and/or one or more integrated antennas that are built into the exterior housing 735B of wireless device 700B, including but not limited to WiFi antennas, cellular antennas, satellite position system (SPS) antennas (e.g., global positioning system (GPS) antennas), and so on.

While internal components of wireless devices such as the wireless devices 700A and 700B can be embodied with different hardware configurations, a basic high-level configuration for internal hardware components is shown as platform 702 in FIG. 7. Platform 702 can receive and execute software applications, data and/or commands transmitted from a radio access network (RAN) that may ultimately come from a core network, the Internet and/or other remote servers and networks (e.g., an application server, web URLs, etc.). Platform 702 can also independently execute locally stored applications without RAN interaction. Platform 702 can include a transceiver 706 operably coupled to an application specific integrated circuit (ASIC) 708, or other processor, microprocessor, logic circuit, or other data processing device. ASIC 708 or other processor executes an application programming interface (API) 710 layer that interfaces with any resident programs in a memory 712 of the electronic device. Memory 712 can be comprised of read-only or random-access memory (RAM and ROM), EEPROM, flash cards, or any memory common to computer platforms. Platform 702 also can include a local database 714 that can store applications not actively used in memory 712, as well as other data. Local database 714 is typically a flash memory cell, but can be any secondary storage device as known in the art, such as magnetic media, EEPROM, optical media, tape, soft or hard disk, or the like.

In one aspect, wireless communications by wireless devices 700A and 700B may be enabled by the transceiver 706 based on different technologies, such as CDMA, W-CDMA, time division multiple access (TDMA), frequency division multiple access (FDMA), Orthogonal Frequency Division Multiplexing (OFDM), GSM, 2G, 3G, 4G, LTE, or other protocols that may be used in a wireless communications network or a data communications network. Voice transmission and/or data can be transmitted to the electronic devices from a RAN using a variety of networks and configurations. Accordingly, the illustrations provided herein are not intended to limit the aspects of the invention and are merely to aid in the description of aspects of aspects of the invention.

Accordingly, aspects of the present disclosure can include a wireless device (e.g., wireless devices 700A, 700B, etc.) configured, and including the ability to perform the functions as described herein. For example, transceiver 706 may be implemented as wireless digital transceiver 600 of FIG. 6, including the receive-processing path. As will be appreciated by those skilled in the art, the various logic elements can be embodied in discrete elements, software modules executed on a processor or any combination of software and hardware to achieve the functionality disclosed herein. For example, ASIC 708, memory 712, API 710 and local database 714 may all be used cooperatively to load, store and execute the various functions disclosed herein and thus the logic to perform these functions may be distributed over various elements. Alternatively, the functionality could be incorporated into one discrete component. Therefore, the features of the wireless devices 700A and 700B in FIG. 7 are to be considered merely illustrative and the invention is not limited to the illustrated features or arrangement.

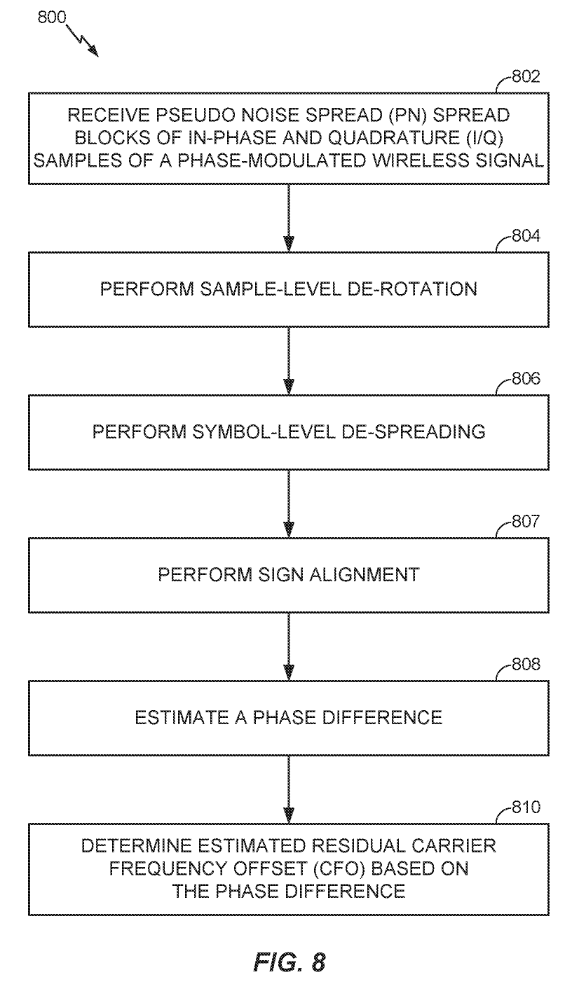

FIG. 8 illustrates an example process 800 for estimating a residual carrier frequency offset (CFO) in a receiver (e.g., transceiver 706 of FIG. 7). In a process block 802, a plurality of pseudo noise (PN) spread blocks (e.g., coded blocks 102A-102C of FIG. 1) of in-phase and quadrature (I/Q) samples (e.g., I/Q samples 106 of FIG. 1) of a phase-modulated wireless signal are received at a digital transceiver (e.g., wireless digital transceiver 600 of FIG. 6, and/or transceiver 706 of FIG. 7). In one example, the phase-modulated wireless signal is an O-QPSK signal. However, in other examples the phase-modulated wireless signal may be an MSK modulated signal, a filtered MSK signal including a GMSK modulated wireless signal, or any other phase-modulated wireless signal that includes PN spreading. As shown in FIG. 1, each PN spread block (e.g., coded blocks 102A-102C) includes a plurality of chips 104, where each chip 104 includes a plurality of I/Q samples 106.

Next, in process block 804, the digital transceiver performs sample-level de-rotation of the I/Q samples. In one example, the sample-level de-rotation of the I/Q samples is performed during a respective symbol period of the I/Q samples and may also include accumulation of the I/Q samples. In one aspect, accumulation of the I/Q samples includes summation of the de-rotated I/Q samples within a modulation symbol. As shown in FIG. 1, after sample-level de-rotation and accumulation of the I/Q samples the resultant chips are 90 degrees apart. For example, the phase 108 of chip C1 is shown as 90 degrees apart from the subsequent phase 109 of chip C2 in FIG. 1. Next, in process block 806, the digital transceiver performs symbol-level de-spreading within each of the plurality of PN-spread blocks (i.e., coded blocks 102A-102C) to generate a corresponding plurality of de-spread blocks. In one aspect, symbol-level de-spreading includes removing the phase differences such that all chips of a respective coded block have the same phase. For example, FIG. 1 illustrates the phase 110 for coded block 0 as being the same for all chips C0-C3 of coded block 0. In one example, each coded block has a phase 110 of a first I/Q sample included in the respective coded block after performing the sample-level de-spreading.

In process block 807, the digital transceiver performs sign alignment on the de-spread blocks to generate a plurality of sign-aligned. For example, as shown in FIG. 1, after sign-alignment, the phase 112 of coded block 102C has been adjusted to be in alignment with the phase 114 of coded block 102B. Next, in process block 808, a phase difference is estimated between two or more adjacent sign-aligned blocks. For example, the phase difference may include the difference between phases 112 and 114, between phases 114 and 116, and/or between phases 112, 114, and 116. In process block 810 the estimated residual CFO is determined based on the phase difference calculated in process block 808. As mentioned above, in some aspects, the phase difference is directly proportional to frequency error. Thus, the estimated residual CFO may be proportional to the phase difference (e.g., calculated in process block 808).

Further, those of skill in the art will appreciate that the various illustrative logical blocks, modules, circuits, and algorithm steps described in connection with the aspects disclosed herein may be implemented as electronic hardware or a combination of computer software and electronic hardware. To clearly illustrate this interchangeability of hardware and hardware-software combinations, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a non-transitory computer-readable media embodying a method for frequency estimation (e.g., CFO estimation) and tracking in a receiver. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method for estimating residual carrier frequency offset (CFO) in a phase-modulated wireless signal having pseudo noise (PN) spreading, the method comprising:
receiving, at a digital transceiver, a plurality of PN spread blocks of in-phase and quadrature (I/Q) samples of the phase-modulated wireless signal;
performing sample-level de-rotation during a respective modulated symbol period;
performing symbol-level de-spreading;
performing sign alignment;
estimating a phase difference; and
determining an estimated residual CFO based on the phase difference.

2. The method of claim 1, wherein the phase-modulated wireless signal is an offset-quadrature phase shift key (O-QPSK) modulated wireless signal.

3. The method of claim 1, wherein the phase-modulated wireless signal is a minimum shift key (MSK) modulated wireless signal.

4. The method of claim 1, wherein the phase-modulated wireless signal is a Gaussian minimum shift key (GMSK) modulated wireless signal.

5. The method of claim 1, wherein performing the sample-level de-rotation comprises performing sample-level de-rotation and accumulation of the I/Q samples during the respective modulated symbol period of the I/Q samples.

6. The method of claim 1, wherein performing symbol-level de-spreading comprises performing symbol-level de-spreading within each of the plurality of PN spread blocks.

7. The method of claim 1, wherein performing symbol-level de-spreading comprising generating de-spread blocks, and wherein performing sign alignment comprises performing sign alignment on each of the de-spread blocks.

8. The method of claim 1, wherein performing sign alignment comprises generating sign-aligned blocks, and wherein estimating the phase difference comprises estimating the phase difference between two or more adjacent sign-aligned blocks.

9. A wireless device, comprising:
a digital transceiver;
memory adapted to store program code; and
a processor coupled to the memory to access and execute instructions included in the program code to direct the wireless device to:
receive, at the digital transceiver, a plurality of pseudo noise (PN) PN spread blocks of in-phase and quadrature (I/Q) samples of the phase-modulated wireless signal;
perform sample-level de-rotation during a respective modulated symbol period;
perform symbol-level de-spreading;
perform sign alignment;
estimate a phase difference; and
determine an estimated residual CFO based on the phase difference.

10. The wireless device of claim 9, wherein the phase-modulated wireless signal is an offset-quadrature phase shift key (O-QPSK) modulated wireless signal.

11. The wireless device of claim 9, wherein the phase-modulated wireless signal is a minimum shift key (MSK) modulated wireless signal.

12. The wireless device of claim 9, wherein the phase-modulated wireless signal is a Gaussian minimum shift key (GMSK) modulated wireless signal.

13. The wireless device of claim 9, the instructions to perform the sample-level de-rotation comprises instructions to perform sample-level de-rotation and accumulation of the I/Q samples during the respective modulated symbol period of the I/Q samples.

14. The wireless device of claim 9, wherein the instructions to perform symbol-level de-spreading comprises instructions to perform symbol-level de-spreading within each of the plurality of PN spread blocks.

15. The wireless device of claim 9, wherein the instructions to perform symbol-level de-spreading comprising instructions to generate de-spread blocks, and wherein the instructions to perform sign alignment comprises instructions to perform sign alignment on each of the de-spread blocks.

16. The wireless device of claim 9, wherein the instructions to perform sign alignment comprises generating sign-aligned blocks, and wherein the instructions to estimate the phase difference comprises instructions to estimate the phase difference between two or more adjacent sign-aligned blocks.

17. A non-transitory computer-readable medium including program code stored thereon for performing wireless communications by a wireless device, the program code comprising instructions to:
receive, at a digital transceiver of the wireless device, a plurality of pseudo noise (PN) spread blocks of in-phase and quadrature (I/Q) samples of the phase-modulated wireless signal;
perform sample-level de-rotation and accumulation of the I/Q samples during a respective modulated symbol period of the I/Q samples;
perform symbol-level de-spreading within each of the plurality of PN spread blocks to generate de-spread blocks;
perform sign alignment on the de-spread blocks to generate sign-aligned blocks;
estimate a phase difference between two or more adjacent sign-aligned blocks; and
determine an estimated residual CFO based on the phase difference.

18. The non-transitory computer-readable medium of claim 17, wherein the phase-modulated wireless signal is an offset-quadrature phase shift key (O-QPSK) modulated wireless signal.

19. The non-transitory computer-readable medium of claim 17, wherein the phase-modulated wireless signal is a minimum shift key (MSK) modulated wireless signal.

20. The non-transitory computer-readable medium of claim 17, wherein the phase-modulated wireless signal is a Gaussian minimum shift key (GMSK) modulated wireless signal.
